(19) United States
(12) Patent Application Publication
(10) Pub. No.: US 2025/0125710 A1
(43) Pub. Date: Apr. 17, 2025

(54) POWER CONVERTER

(71) Applicant: Murata Manufacturing Co., Ltd., Nagaokakyo-shi (JP)

(72) Inventors: Gang LI, Wuhan (CN); Liang MA, Wuhan (CN)

(21) Appl. No.: 18/913,043

(22) Filed: Oct. 11, 2024

(30) Foreign Application Priority Data
Oct. 17, 2023 (CN) 202311346205.0

(51) Int. Cl. H02M 1/00; H02M 7/219

(52) U.S. Cl. CPC H02M 1/0064; H02M 1/0043; H02M 7/219

(57) ABSTRACT

A power converter includes a first bridge arm including a first switch and a second switch connected in series such that the first switch is connected to the second switch to define a first connection point, a second bridge arm including a third switch and a fourth switch connected in series such that the third switch is connected to the fourth switch to define a second connection point, a first LC resonant cavity connected between the first connection point and the second connection point, a first rectifier and a second rectifier including switches, and a coupling inductance connected to the second switch, the third switch, the first rectifier and the second rectifier respectively, such that a center tap of the coupling inductance is connected to a load.

### CROSS REFERENCE TO RELATED APPLICATIONS

This application claims the benefit of priority to Chinese Patent Application No. 202311346205.0 filed on Oct. 17, 2023. The entire contents of this application are hereby incorporated herein by reference.

### BACKGROUND OF THE INVENTION

### 1. Field of the Invention

The present disclosure relates to power converters, in particular to non-isolated power converters.

### 2. Description of the Related Art

A power converter is an electronic device that may convert a certain type of current into another type of current. There are DC power conversion and AC power conversion. Most intermediate bus converters (IBCs) provide isolation from input to output by using a transformer, and generally require an inductor for output filtering.

In existing communication systems, an isolated intermediate bus architecture is widely used for safety and power supply efficiency considerations. In such architecture, an input voltage of the system is converted into an intermediate voltage by an isolated intermediate bus converter (IBC), and then converted into a voltage required by a load circuit by a plurality of post-stage non-isolated load point power supplies.

Since a range of the input voltage that the load point power supply at the post-stage of the intermediate bus converter may adapt to is limited, the intermediate bus converter has to control an output voltage within a certain range. In order to adapt to a wider range of the input voltage, when the input voltage is transformed by the intermediate bus converter, an energy storage element such as an inductor has to continuously store and release more energy in the voltage conversion due to the wider range of input voltage, resulting in an increase in the volume and loss of the energy storage element.

However, non-isolated intermediate bus converters have been proposed in many new applications to achieve smaller dimension, higher efficiency and lower costs.

### SUMMARY OF THE INVENTION

According to an example embodiment of the present disclosure, a power converter includes a first bridge arm including a first switch and a second switch connected in series to define a first connection point, a second bridge arm including a third switch and a fourth switch connected in series to define a second connection point, a first LC resonant cavity connected between the first connection point and the second connection point, a first rectifier and a second rectifier including switches, and a coupling inductance connected to the second switch, the third switch, the first rectifier and the second rectifier respectively; wherein a center tap of the coupling inductance is connected to a load.

In an example, in a power converter according to an example embodiment of the present disclosure, the coupling inductance includes a first coil, a second coil, a third coil and a fourth coil, where the first coil is magnetically coupled with the second coil, the third coil is magnetically coupled with the fourth coil, a center tap of a combination of the first coil and the second coil is connected to a center tap of a combination of the third coil and the fourth coil and the center taps are connected to the load. The first coil is connected to the second switch, the second coil is connected to the first rectifier, the third coil is connected to the third switch, and the fourth coil is connected to the second rectifier.

In an example, in a power converter according to an example embodiment of the present disclosure, the coupling inductance includes a first coupling inductor and a second coupling inductor magnetically coupled with the first coupling inductor. An end of the first coupling inductor is connected to the second switch and the third switch and is connected to the load, and another end of the first coupling inductor is connected to the first rectifier and the second rectifier respectively. The second coupling inductor is connected in series with the first LC resonant cavity between the first connection point and the second connection point.

In an example, in a power converter according to an example embodiment of the present disclosure, the first coupling inductor includes a first coil and a second coil connected in series. An end of the first coil is connected to an end of the second coil to define the end of the first coupling inductor, another end of the first coil and another end of the second coil form the another end of the first coupling inductor, the another end of the first coil is connected to the first rectifier, and the another end of the second coil is connected to the second rectifier.

In an example, in a power converter according to an example embodiment of the present disclosure, the first bridge arm further includes a fifth switch and a sixth switch configured such that the fifth switch and the sixth switch are connected in series with the first switch and the second switch, and the fifth switch is connected to the sixth switch to define a third connection point. The second bridge arm further includes a seventh switch and an eighth switch configured such that the seventh switch and the eighth switch are connected in series with the third switch and the fourth switch, and the seventh switch is connected to the eighth switch to define a fourth connection point. The power converter further includes a second LC resonant cavity connected between the third connection point and the fourth connection point. The fifth switch is connected to the second switch to define a fifth connection point, the eighth switch is connected to the third switch to define a sixth connection point, and the coupling inductance is connected between the fifth connection point and the sixth connection point.

In an example, in a power converter according to an example embodiment of the present disclosure, the coupling inductance includes a first coil and a second coil connected in series, and a center tap of a combination of the first coil and the second coil is connected to the load. The first coil is connected to the sixth connection point, and is connected to the first rectifier. The second coil is connected to the fifth connection point, and is connected to the second rectifier.

In an example, in a power converter according to an example embodiment of the present disclosure, the coupling inductance includes a first coil, a second coil, a third coil and a fourth coil configured such that the first coil is connected in series with the second coil, the third coil is connected in series with the fourth coil, a center tap of a combination of the first coil and the second coil is connected to a center tap of a combination of the third coil and the fourth coil and the center taps are connected to the load. The first coil is connected to the sixth connection point, the second coil is connected to the fifth connection point, the third coil is connected to the first rectifier, and the fourth coil is connected to the second rectifier. The first coil is magnetically coupled with the fourth coil, and the second coil is magnetically coupled with the third coil.

In an example, in a power converter according to an example embodiment of the present disclosure, a first group of switches include the first switch, the third switch and the second rectifier. A second group of switches include the second switch, the fourth switch and the first rectifier. The first group of switches are controlled to be turned on or off synchronously. The second group of switches are controlled to be turned on or off synchronously. The first group of switches and the second group of switches are controlled to have an identical turn-on duty cycle.

In an example, in a power converter according to an example embodiment of the present disclosure, each of the first group of switches and the second group of switches are controlled to have a turn-on duty cycle of 50% without considering dead zone, and a phase difference between a control signal of the first group of switches and a control signal of the second group of switches is 180 degrees.

In an example, in a power converter according to an example embodiment of the present disclosure, a first group of switches include the first switch, the third switch, the sixth switch, the eighth switch and the second rectifier. A second group of switches include the second switch, the fourth switch, the fifth switch, the seventh switch and the first rectifier. The first group of switches are controlled to be turned on or off synchronously. The second group of switches are controlled to be turned on or off synchronously. The first group of switches and the second group of switches are controlled to have identical turn-on duty cycle.

In an example, in a power converter according to an example embodiment of the present disclosure, the first LC resonant cavity includes a first resonant inductor and a first resonant capacitor connected in series. The second LC resonant cavity includes a second resonant inductor and a second resonant capacitor connected in series. A capacitance of the first resonant capacitor is equal to a capacitance of the second resonant capacitor.

In an example, in a power converter according to an example embodiment of the present disclosure, each of a resonant frequency of the first LC resonant cavity and a resonant frequency of the second LC resonant cavity is equal to an operation frequency of the power converter.

In an example, in a power converter according to an example embodiment of the present disclosure, a number of turns of the first coil is equal to a number of turns of the second coil.

In an example, in a power converter according to an example embodiment of the present disclosure, the first coil, the second coil, the third coil and the fourth coil have a same number of turns.

The above and other elements, features, steps, characteristics and advantages of the present invention will become more apparent from the following detailed description of the example embodiments with reference to the attached drawings.

### BRIEF DESCRIPTION OF THE DRAWINGS

The purposes, advantages and features of the present disclosure mentioned above will become more apparent through the detailed description of example embodiments with reference to the following combined accompanying drawings.

FIG. 1 is a block diagram illustrating a configuration structure of a main portion of a power converter according to a first example embodiment of the present invention.

FIG. 2 is a schematic diagram illustrating a first mode of the power converter according to the first example embodiment of the present invention.

FIG. 3 is a schematic diagram illustrating a second mode of the power converter according to the first example embodiment of the present invention.

FIG. 4 is a block diagram illustrating a configuration structure of a main portion of a power converter according to a second example embodiment of the present invention.

FIG. 5 is a block diagram illustrating a configuration structure of a main portion of a power converter according to a third example embodiment of the present invention.

FIG. 6 is a schematic diagram illustrating a first mode of the power converter according to the third example embodiment of the present invention.

FIG. 7 is a schematic diagram illustrating a second mode of the power converter according to the third example embodiment of the present invention.

FIG. 8 is a schematic diagram illustrating voltage waveforms and current waveforms of control signals in the power converter according to the third example embodiment of the present invention.

FIG. 9 is a block diagram illustrating a configuration structure of a main portion of a power converter according to a fourth example embodiment of the present invention.

FIG. 10 is a schematic diagram illustrating a first mode of the power converter according to the fourth example embodiment of the present invention.

FIG. 11 is a schematic diagram illustrating a second mode of the power converter according to the fourth example embodiment of the present invention.

### DETAILED DESCRIPTION OF THE EXAMPLE EMBODIMENTS

The present disclosure is further described in detail below in conjunction with the accompanying drawings and example embodiments. It may be understood that the specific example embodiments described herein are only used to explain the present invention, rather than to limit the present invention. Furthermore, it should be noted that, for ease of description, only the parts related to example embodiments of the present invention are shown in the accompanying drawings. In addition, there are cases where the same elements are labeled with the same symbols and repeated descriptions are omitted. In addition, there are cases where repeated descriptions are omitted for elements with the same or corresponding functions and structures.

Example embodiments of the present disclosure provide power converters each being capable of achieving soft switching. Hereinafter, example embodiments of the present disclosure will be explained in detail with reference to the accompanying drawings.

### First Example Embodiment

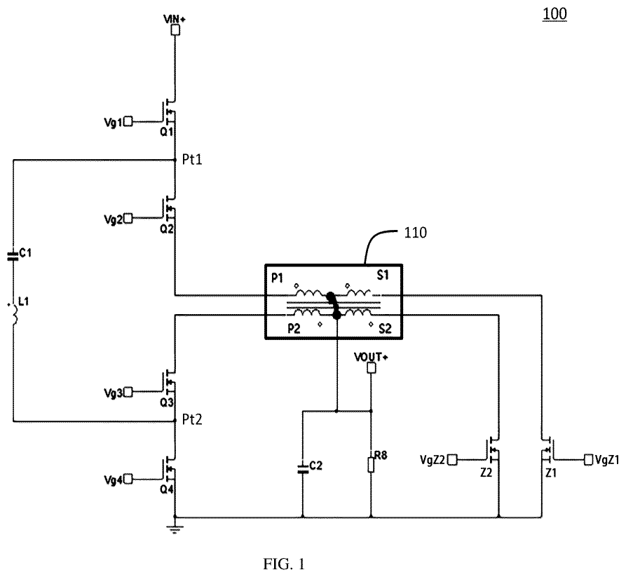

FIG. 1 is a block diagram illustrating a configuration structure of a main portion of a power converter according to the first example embodiment of the present disclosure. As shown in FIG. 1, the power converter 100 in the first example embodiment of the present disclosure preferably includes six switches Q1 to Q6, a coupling inductance and an LC resonant cavity. In this example embodiment, the switches may be, for example, various transistors, and the same applies to other example embodiments.

As shown in FIG. 1, in the first example embodiment of the present disclosure, the power converter 100 includes a switch Q1, a switch Q2, a switch Q3, a switch Q4, an LC resonant cavity, a first rectifier Z1, a second rectifier Z2, and a coupling inductance 110. In addition, the first rectifier Z1 and the second rectifier Z2 may be switches. In the power converter 100 of this example embodiment, the switch Q1 (first switch) and the switch Q2 (second switch) connected in series may be implemented to define a first bridge arm, and the switch Q1 is connected to the switch Q2 to define a first connection point Pt1. The switch Q3 (third switch) and the switch Q4 (fourth switch) connected in series may be implemented to define a second bridge arm, and the switch Q3 is connected to the switch Q4 to define a second connection point Pt2. In addition, in the power converter 100 of this example embodiment, the LC resonant cavity (first LC resonant cavity) is connected between the first connection point Pt1 and the second connection point Pt2. The LC resonant cavity includes a resonant capacitor C1 and a resonant inductor L1. Here, the resonant inductor L1 may include a circuit parasitic inductance.

In this example embodiment, the coupling inductance 110 is connected to the switch Q2, the switch Q3, the first rectifier Z1 and the second rectifier Z2 respectively, and a center tap of the coupling inductance 110 is connected to a load R8. As an example embodiment, as shown in FIG. 1, the coupling inductance 110 includes a coil P1 (first coil), a coil S1 (second coil), a coil P2 (third coil) and a coil S2 (fourth coil), where the coil P1 (first coil) is magnetically coupled with the coil S1 (second coil), and the coil P2 (third coil) is magnetically coupled with the coil S2 (fourth coil). In this example embodiment, a center tap of a combination of the coil P1 and the coil S1 may be connected to a center tap of a combination of the coil P2 and the coil S2, and the center taps may be connected to the load R8. The coil P1 and the coil P2 are connected in series, and the coil S1 and the coil S2 are connected in series.

In this example embodiment, for example, the coil P1 may be connected to the switch Q2, the coil S1 may be connected to the first rectifier Z1, the coil P2 may be connected to the switch Q3, and the coil S2 may be connected to the second rectifier Z2. In an example embodiment, the first rectifier Z1 is connected between the coil S1 and a reference potential, and the second rectifier Z2 is connected between the coil S2 and the reference potential. In addition, in this example embodiment, the switch Q1 may be connected to an input power supply VIN+, the switch Q4 may be connected to the reference potential, the load R8 may be connected between the coupling inductance 110 and the reference potential, and a capacitor C2 may be connected in parallel with the load R8. Here, the reference potential may be a ground potential.

In this example embodiment, regarding polarity relationships of the coil P1, the coil S1, the coil P2 and the coil S2, common-polarity terminals are shown with dots in FIG. 1. Since the power converter 100 of this example embodiment is implemented to be a non-isolated power converter, there are no strictly defined primary and secondary sides as referred to in an isolated power converter.

It should be noted that the power converter 100 of this example embodiment is further provided with a control circuit to provide control signals Vg1 to Vg4, VgZ1, and VgZ2 to gates of the switches Q1-Q4, first rectifier Z1 and second rectifier Z2, where the first rectifier Z1 and the second rectifier 22 include switches. However, since the present disclosure does not involve the specific structure of the control circuit, the control circuit is not shown and detailed description of the control circuit is omitted, in order to make the description of the present disclosure clearer.

Next, operation modes of the power converter 100 of this example embodiment will be described.

In the power converter 100 of this example embodiment, control signals Vg1, Vg3 and VgZ2 corresponding to a group of the switch Q1, the switch Q3 and the second rectifier 22 are synchronized, and control signals Vg2, Vg4 and VgZ1 corresponding to a group of the switch Q2, the switch Q4, and the first rectifier Z1 are synchronized. For example, when the control signals Vg1, Vg3 and VgZ2 are at high level, the control signals Vg2, Vg4 and VgZ1 are at low level. A phase difference between each of the control signals Vg1, Vg3 and VgZ2 and each of the control signals Vg2, Vg4 and VgZ1 is 180 degrees. In a half cycle, the switch Q1, the switch Q3 and the second rectifier Z2 are turned on by the control signals Vg1, Vg3 and VgZ2 at high level, so that the switch Q1, the switch Q3 and the second rectifier Z2 are simultaneously turned on for a duty cycle of 50%. In the other half cycle, the switch Q2, the switch Q4 and the first rectifier Z1 are turned on by the control signals Vg2, Vg4 and VgZ1 at high level, so that the switch Q2, the switch Q4 and the first rectifier Z1 are simultaneously turned on for a duty cycle of 50%. It should be noted that the duty cycle here is a duty cycle without considering dead zone.

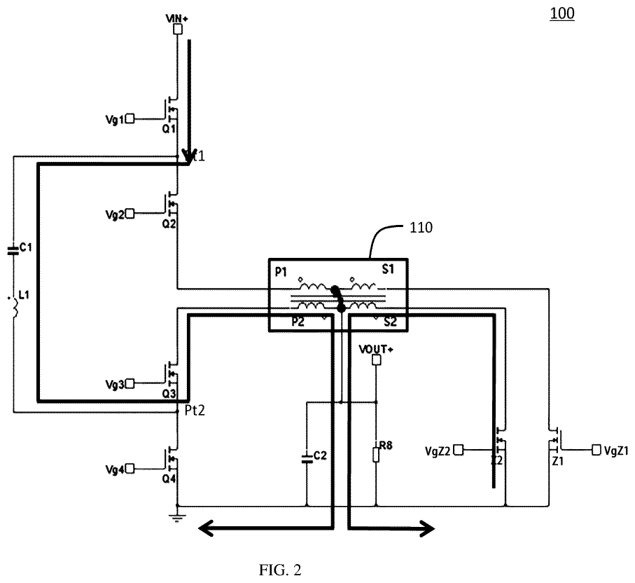

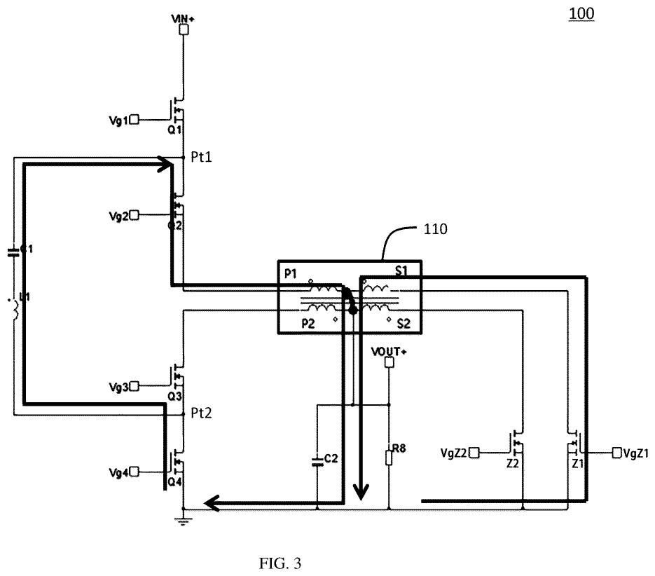

FIG. 2 is a schematic diagram illustrating a first mode of the power converter according to the first example embodiment of the present disclosure. FIG. 2 is a schematic diagram showing a current flow direction when the switch Q1, the switch Q3 and the second rectifier Z2 are turned on. FIG. 3 is a schematic diagram illustrating a second mode of the power converter according to the first example embodiment of the present disclosure. FIG. 3 is a schematic diagram showing a current flow direction when the switch Q2, the switch Q4 and the first rectifier Z1 are turned on.

When the switch Q1, the switch Q3 and the second rectifier 22 are turned on, two current loops are generated in the power converter 100 as shown in FIG. 2. In one of the two current loops, the current flows to the load through the switch Q1, the LC resonant cavity defined by the resonant capacitor C1 and the resonant inductor L1, the switch Q3, and the coil P2 included in the coupling inductance 110, and returns to the ground. In the other one of the two current loops, the current flows to the load through the second rectifier 22 and the coil S2 included in the coupling inductance 110, and returns to the ground. Since the coil P2 is coupled with the coil S2, the currents in the two current loops have the same magnitude in a case that a number of turns of the coil P2 is equal to a number of turns of the coil S2 and the parasitic is ignored. It should be noted that in the process of operating in this half cycle, the resonant capacitor C1 is charged.

When operating in the other half cycle, that is, when the switch Q2, the switch Q4 and the first rectifier Z1 are turned on, two current circuits may be defined in the power converter 100 as shown in FIG. 3. In one of the two current circuits, the current flows to the coupling inductance 110 through the switch Q4, the LC resonant cavity and the switch Q2, flows to the load through the coil P1 included in the coupling inductance 110, and returns to the ground. In the other one of the two current circuits, the current flows to the load through the first rectifier Z1 and the coil S1 included in the coupling inductance 110, and returns to ground. Similarly, since the coil P1 is coupled with the coil S1, the currents in the two current loops have the same magnitude in a case that a number of turns of the coil P1 is equal to a number of turns of the coil S1 and the parasitic is ignored. It should be noted that in the process of operating in this half cycle, the resonant capacitor C1 is discharged.

Regarding a relationship between an output voltage Vo and an input voltage Vin, the number of turns of the coil P1 is equal to the number of turns of the coil P2, the number of turns of the coil S1 is equal to the number of turns of the coil S2, and Vo=Vin*n2/[2*(n1+n2)], where n1 represents the number of turns of each of the coil P1 and the coil P2, and n2 represents the number of turns of each of the coil S1 and the coil S2. When the coil P1, the coil P2, the coil S1 and the coil S2 have a same number of turns, a gain ratio of the output voltage to the input voltage is 1:4.

In the power converter 100 of this example embodiment, the resonant inductor L1 may include a parasitic inductance in the circuit. The resonant inductor L1 is independent of the coil P1, the coil S1, the coil P2 and the coil S2, and there is no coupling s between the resonant inductor L1 and the coils P1, S1, P2, and S2.

In the power converter 100 of this example embodiment, by connecting the LC resonant cavity between the connection point Pt1 and the connection point Pt2, a resonant current may be generated. In a case that a switching frequency of each switch is equal to a resonant frequency of the LC resonant cavity, soft switching may be achieved, so that each switch may be turned on at zero voltage and turned off at zero current, thus reducing the switching loss of each switch. Moreover, the current of each of the switches Q1 and Q3 and the switches Q2 and Q4 flows to the load, thus reducing the current of the rectifiers 21 and Z2 implemented as switches.

### Second Example Embodiment

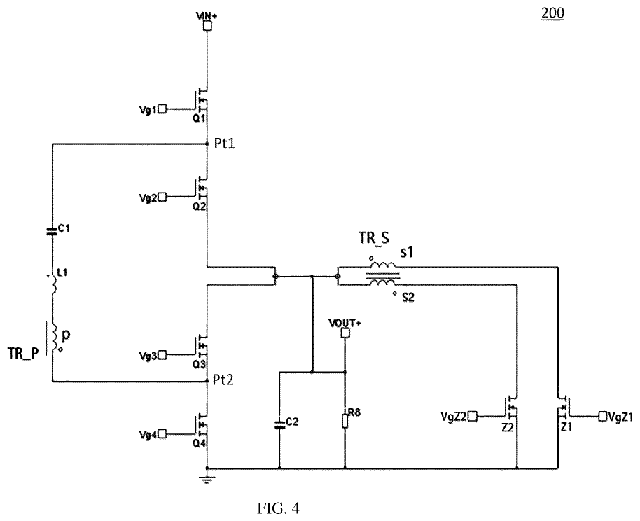

FIG. 4 is a block diagram illustrating a configuration structure of a main portion of a power converter according to a second example embodiment of the present disclosure.

The power converter 200 of this second example embodiment is different from the power converter 100 of the first example embodiment mainly in that the structure of the coupling inductance is different, that is, some of the coils of the coupling inductance is connected to the LC resonant cavity. Hereinafter, description will be made mainly on the differences. In the second example embodiment, structures that are same as those in the first example embodiment are denoted by same reference numerals, and descriptions of the same structures and the same functions and effects based on the same structures are omitted.

As shown in FIG. 4, in the power converter 200 of this example embodiment, the coupling inductance includes a first coupling inductor TR_S and a second coupling inductor TR_P magnetically coupled with the first coupling inductor TR_S. An end of the first coupling inductor TR_S is connected to the switch Q2 and the switch Q3 and is connected to the load, and another end of the first coupling inductor TR_S is connected to the first rectifier Z1 and the second rectifier Z2 respectively. The second coupling inductor TR_P is connected in series with the LC resonant cavity between the first connection point Pt1 and the second connection point Pt2.

In this example embodiment, as shown in FIG. 4, for example, the first coupling inductor TR_S may include a coil S1 (first coil) and a coil S2 (second coil) connected in series. An end of the coil S1 is connected to an end of the coil S2 to define the end of the first coupling inductor TR_S. Another end of the coil S1 and another end of the coil S2 form the another end of the first coupling inductor TR_S. The another end of the coil S1 is connected to the first rectifier 21, and the another end of the coil S2 is connected to the second rectifier Z2. In addition, in this example embodiment, each of the first rectifier Z1 and the second rectifier 22 may be connected between the first coupling inductor TR_S and a reference potential. In addition, in this example embodiment, for example, the first rectifier Z1 may be connected to an opposite-polarity terminal of the coil S1, and the second rectifier Z2 may be connected to a common-polarity terminal of the coil S2, or vice versa.

In this example embodiment, the current flow direction is the same as that of the first example embodiment shown in FIG. 1, and the same effect as the first example embodiment may be achieved, which will not be repeated here.

According to the structure of the first example embodiment and the structure of the second example embodiment, in this non-isolated transformation, energy may be provided to the output through the input in a half cycle, an effect similar to a semi-bridge effect may be achieved, and the input current may be half a sine wave.

### Third Example Embodiment

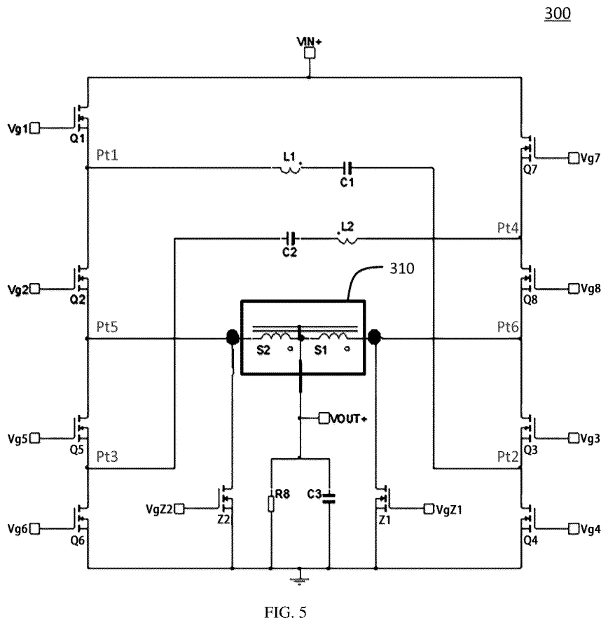

FIG. 5 is a block diagram illustrating a configuration structure of a main portion of the power converter according to a third example embodiment of the present disclosure.

As shown in FIG. 5, the power converter 300 of this example embodiment includes a first bridge arm, a second bridge arm, a first LC resonant cavity, a second LC resonant cavity and a coupling inductance 310. The first bridge arm includes a switch Q1 (first switch), a switch Q2 (second switch), a switch Q5 (fifth switch) and a switch Q6 (sixth switch) sequentially connected in series. The second bridge arm includes a switches Q7 (seventh switch), a switch Q8 (eighth switch), a switch Q3 (third switch), and a switch Q4 (fourth switch). The switch Q1 is connected to the switch Q2 to define a first connection point Pt1. The switch Q3 is connected to the switch Q4 to define a second connection point Pt2. The switch Q5 is connected to the switch Q6 to define a third connection point Pt3. The switch Q7 is connected to the switch Q8 to define a fourth connection point Pt4. In addition, the switch Q2 is connected to the switch Q5 to define a fifth connection point Pt5. The switch Q8 is connected to the switch Q3 to define a sixth connection point Pt6. The first LC resonant cavity is connected between the first connection point Pt1 and the second connection point Pt2, and the second LC resonant cavity is connected between the third connection point Pt3 and the fourth connection point Pt4. The coupling inductance 310 is connected between the fifth connection point Pt5 and the sixth connection point Pt6. As shown in FIG. 5, in an example embodiment, the coupling inductance 310 includes a coil S1 (first coil) and a coil S2 (second coil) connected in series, a center tap of a combination of the coil S1 and the coil S2 is connected to a load R8, the coil S1 is connected to the sixth connection point Pt6, the coil S2 is connected to the fifth connection point Pt5, and the coil S2 is connected to the second rectifier Z2.

In addition, in this example embodiment, as shown in FIG. 5, for example, the first rectifier Z1 may be connected between the coil S1 and a reference potential, and the second rectifier Z2 may be connected between the coil S2 and the reference potential.

In addition, in the power converter 300 of this example embodiment, the coil S1 is magnetically coupled with the coil S2, a center tap of the coil S1 is connected to a center tap of the coil S2, and the center taps are connected to the load R8.

In addition, in the power converter 300 of this example embodiment, the first LC resonant cavity may include a resonant capacitor C1 and a resonant inductor L1 connected in series, and the second LC resonant cavity may include a resonant capacitor C2 and a resonant inductor L2 connected in series. In this example embodiment, a capacitance of the resonant capacitor C1 may be equal to a capacitance of the resonant capacitor C2. In addition, the resonant inductor L1 and the resonant inductor L2 may include circuit parasitic inductances.

In this example embodiment, the switch Q1 and the switch Q7 may be connected to an input power supply VIN+, the switch Q4 and the switch Q6 may be connected to the reference potential, the load R8 may be connected between the coupling inductance 310 and the reference potential, and a capacitor C3 is connected in parallel with the load R8. Here, the reference potential may be a ground potential.

In this example embodiment, regarding the polarity relationship between the coil S1 and the coil S2, common-polarity terminals are shown with dots in FIG. 5. In this example embodiment, an opposite-polarity terminal of the coil S1 and a common-polarity terminal of the coil S2 are connected to the load. Alternatively, a common-polarity terminal of the coil S1 and an opposite-polarity terminal of the coil S2 are connected to the load. Since the power converter 300 in this example embodiment is implemented to be a non-isolated power converter, there is no strict definition of the so-called primary and secondary sides in the isolated power converter.

It should be noted that the power converter 300 of this example embodiment is further provided with a control circuit to provide control signals Vg1 to Vg8, VgZ1, and VgZ2 to gates of the switches Q1 to Q8, first rectifier Z1 and second rectifier Z2. However, since the present disclosure does not involve the specific structure of the control circuit, the control circuit is not shown and detailed description of the control circuit is omitted, in order to make the description of the present disclosure clearer.

Next, operation modes of the power converter 300 of this example embodiment will be described.

In the power converter 300 of this example embodiment, a first group of switches include the switch Q1, the switch Q3, the switch Q6, the switch Q8 and the second rectifier Z2. A second group of switches include the switch Q2, the switch Q4, the switch Q5, the switch Q7 and the first rectifier Z1. The first group of switches are controlled to be turned on or off synchronously, and the corresponding control signals Vg1, Vg3, Vg6, Vg8 and VgZ2 are synchronized. The second group of switches are controlled to be turned on or off synchronously, and the corresponding control signals Vg2, Vg4, Vg5, Vg7 and VgZ1 are synchronized. For example, the first group of switches and the second group of switches may be controlled to have identical turn-on duty cycle.

For example, when the control signals Vg1, Vg3, Vg6, Vg8 and VgZ2 are at high level, and the control signals Vg2, Vg4, Vg5, Vg7 and VgZ1 are at low level, the control signals Vg1, Vg3, Vg6, Vg8 and VgZ2 are complementary to the control signals Vg2, Vg4, Vg5, Vg7 and VgZ1, with a phase difference of 180 degrees. In a half cycle, the switch Q1, the switch Q3, the switch Q6, the switch Q8 and the second rectifier 22 are turned on by the control signals Vg1, Vg3, Vg6, Vg8 and VgZ2 at high level, so that the switch Q1, the switch Q3, the switch Q6, the switch Q8 and the second rectifier 22 are simultaneously turned on for duty cycle of 50%. In another half cycle, the switch Q2, the switch Q4, the switch Q5, the switch Q7 and the first rectifier Z1 are turned on by the control signals Vg2, Vg4, Vg5, Vg7 and VgZ1 at high level, so that the switch Q2, the switch Q4, the switch Q5, the switch Q7 and the first rectifier Z1 are simultaneously turned on for duty cycle of 50%. It should be noted that the duty cycle here is a duty cycle without considering dead zone.

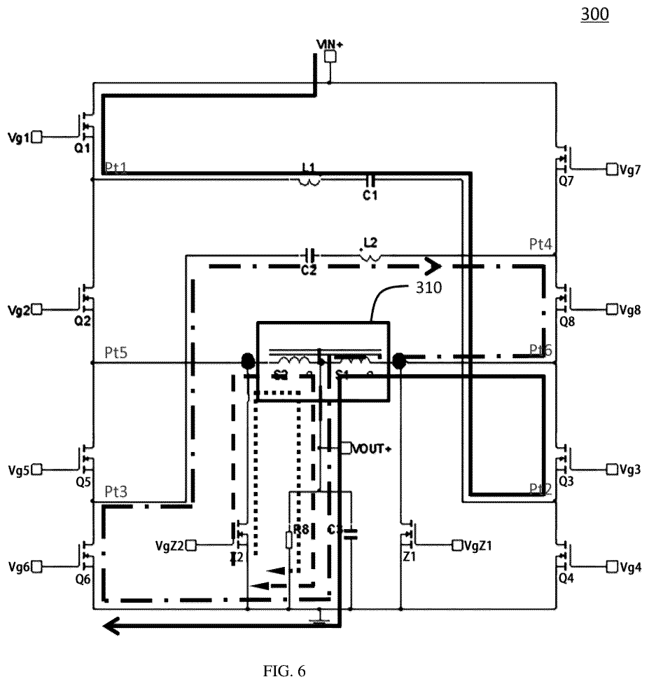

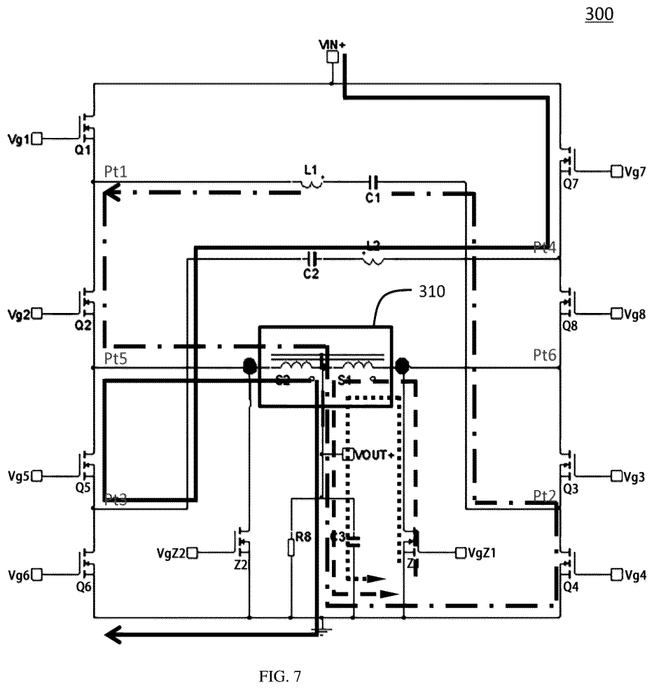

FIG. 6 is a schematic diagram illustrating a first mode of the power converter according to the third example embodiment of the present disclosure. FIG. 6 is a schematic diagram showing a current flow direction when a switch Q1, a switch Q3, a switch Q6, a switch Q8 and a second rectifier Z2 are turned on. FIG. 7 is a schematic diagram illustrating a second mode of the power converter of the third example embodiment of the present disclosure. FIG. 7 is a schematic diagram showing a current flow direction when a switch Q2, a switch Q4, a switch Q5, a switch Q7, and a first rectifier Z1 are turned on.

When the switch Q1, the switch Q3, the switch Q6, the switch Q8, and the second rectifier 22 are turned on, as shown in FIG. 6, in the power converter 300, current flows to the load through the switch Q1, the first LC resonant cavity defined by the resonant capacitor C1 and the resonant inductor L1, the switch Q3, and the coil S1 included in the coupling inductance 310, and returns to ground. Furthermore, the current flows to the load through the switch Q6, the second LC resonant cavity defined by the resonant capacitor C2 and the resonant inductor L2, the switch Q8, the coil S1 included in the coupling inductance 310, and returns to ground. In addition, through magnetic coupling between the coil S1 and the coil S2, the current flows to the load through the second rectifier Z2 and the coil S2 included in the coupling inductance 310, and returns to ground. Since the coil S1 is magnetically coupled with the coil S2, the current flowing through the coil S1 is equal to the current flowing through the coil S2 in magnitude in a case that a number of turns of the coil S1 is equal to a number of turns of the coil S2 and the parasitic is ignored. It should be noted that in the process of operating in this half cycle, the resonant capacitor C1 is charged and the resonant capacitor C2 is discharged.

When operating in the other half cycle, that is, when the switch Q2, the switch Q4, the switch Q5, the switch Q7 and the first rectifier Z1 are turned on, as shown in FIG. 7, in the power converter 300, a current flows to the load through the switch Q7, the second LC resonant cavity defined by the resonant capacitor C2 and the resonant inductor L2, the switch Q5, and the coil S2 included in the coupling inductance 310, and returns to ground. Moreover, the current flows to the load through the switch Q4, the first LC resonant cavity defined by the resonant capacitor C1 and the resonant inductor L1, the switch Q2, and the coil S2 included in coupling inductance 310, and returns to ground. In addition, through the magnetic coupling between the coil S2 and the coil S1, the current flows to the load through the first rectifier 21 and the coil S1 included in the coupling inductance 310, and returns to ground. Similarly, since the coil S1 is magnetically coupled with the coil S2, the current flowing through the coil S1 is equal to the current flowing through the coil S2 in magnitude in a case that a number of turns of the coil S1 is equal to a number of turns of the coil S2 and the parasitic is ignored. It should be noted that in the process of operating in this half cycle, the resonant capacitor C2 is charged and the resonant capacitor C1 is discharged.

Regarding a relationship between an output voltage Vo and an input voltage Vin, a gain ratio of the output voltage to the input voltage is 1:4 when the number of turns of the coil S1 is equal to the number of turns of the coil S2.

In the power converter 300 of this example embodiment, the resonant inductor L1 and the resonant inductor L2 are independent of the coil S1 and the coil S2, and there is no coupling between the resonant inductors L1 and L2 and the coils S1 and S2.

In the power converter 300 of this example embodiment, by connecting the first LC resonant cavity between the connection point Pt1 and the connection point Pt2, and connecting the second LC resonant cavity between the connection point Pt3 and the connection point Pt4, a resonant current may be generated. In a case that a switching frequency of each switch is equal to a resonant frequency of each of the first LC resonant cavity and the second LC resonant cavity, soft switching may be achieved, so that each switch may be turned on at zero voltage and turned off at zero current, thus reducing the switching loss of each switch. Moreover, as compared with the isolated converter, current may be greatly reduced for a secondary side of traditional LC. Moreover, since the coils are fully coupled, the number of turns of the coils may be reduced, and the winding of the coils is facilitated. Furthermore, the power converter of this example embodiment may be easily driven due to its structure. In addition, according to the structure of the power converter of this example embodiment, when the number of turns of the coil S1 is equal to the number of turns of the coil S, a symmetrical structure is achieved. Since the current flows through the coil S1 and the coil S2 simultaneously, a peak coefficient may be reduced, and an input current may be reduced. Moreover, according to the structure of the power converter of this example embodiment, by integrating the power converter as a full-bridge like structure, energy may be supplied from the so-called primary side to the so-called secondary side in both half cycles, thus reducing the input current.

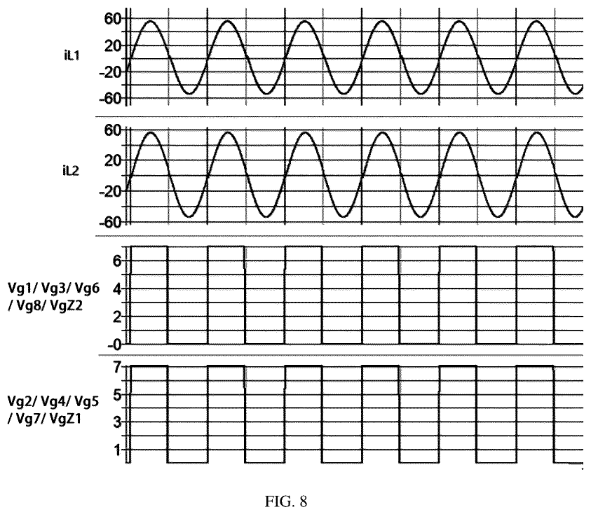

The operations of the power converter 300 of this example embodiment are simulated by simulation. FIG. 8 is a schematic diagram illustrating voltage waveforms and current waveforms of control signals in the power converter according to the third example embodiment of the present disclosure. In FIG. 8, the control signals Vg1, Vg3, Vg6, Vg8, VgZ2 and the control signals Vg2, Vg4, Vg5, Vg7, VgZ1 are shown as an example, and a resonant current iL1 of the first LC resonant cavity and a resonant current iL2 of the second LC resonant cavity are shown as an example.

### Fourth Example Embodiment

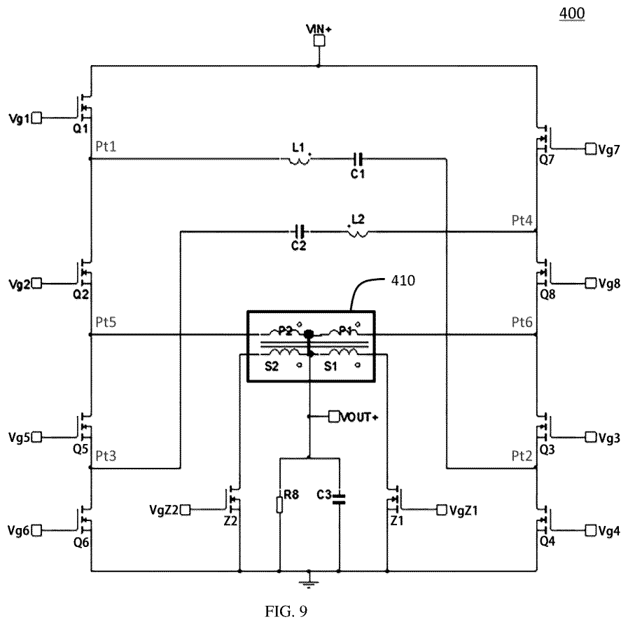

FIG. 9 is a block diagram illustrating a configuration structure of a main portion of a power converter according to a fourth example embodiment of the present disclosure.

The power converter 400 of this example embodiment is different from the power converter 300 of the third example embodiment mainly in that the structure of the coupling inductance is different. Hereinafter, description will be made mainly on the differences. In the fourth example embodiment, structures that are same as those in the first example embodiment are denoted by same reference numerals, and descriptions of the same structures and the same functions and effects based on the same structures are omitted.

As shown in FIG. 9, in the power converter 400 of this example embodiment, the coupling inductance 410 includes a coil P1 (first coil), a coil P2 (second coil), a coil S1 (third coil) and a coil S2 (fourth coil), where the coil P1 and the coil P2 are connected in series, and the coil S1 and the coil S2 are connected in series. A center tap of a combination of the coil P1 and the coil P2 is connected to a center tap of a combination of the coil S1 and the coil S2, and the center taps are connected to a load R8. The coil P1 is connected to a sixth connection point Pt6. The coil P2 is connected to a fifth connection point Pt5. The coil S1 is connected to a first rectifier Z1. The coil S2 is connected to a second rectifier 22. The coil P1 is magnetically coupled with the coil S2. The coil P2 is magnetically coupled with the coil S1.

Similarly, in the power converter 400 of this example embodiment, the first group of switches include a switch Q1, a switch Q3, a switch Q6, a switch Q8 and a second rectifier Z2. The second group of switches include a switch Q2, a switch Q4, a switch Q5, a switch Q7 and a first rectifier Z1. The first group of switches are controlled to be turned on or off synchronously, and the corresponding control signals Vg1, Vg3, Vg6, Vg8 and VgZ2 are synchronized. The second group of switches are controlled to be turned on or off synchronously, and the corresponding control signals Vg2, Vg4, Vg5, Vg7 and VgZ1 are synchronized.

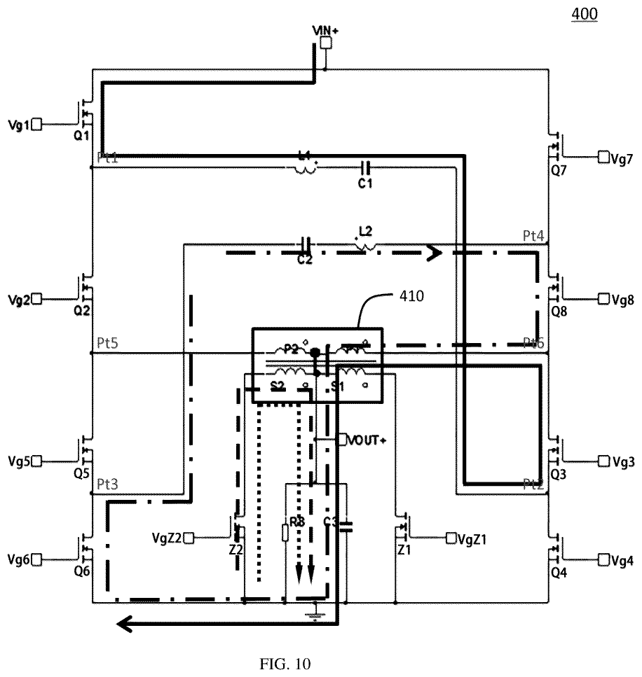

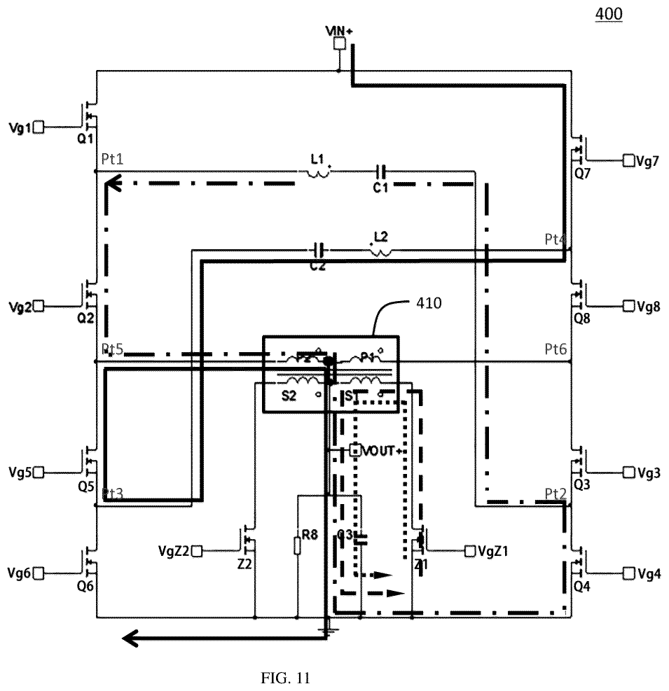

FIG. 10 is a schematic diagram illustrating a first mode of the power converter according to the fourth example embodiment of the present disclosure. FIG. 10 is a schematic diagram showing a current flow direction when a switch Q1, a switch Q3, a switch Q6, a switch Q8 and a second rectifier 22 are turned on. FIG. 11 is a schematic diagram illustrating a second mode of the power converter according to the fourth example embodiment of the present disclosure. FIG. 11 is a schematic diagram showing a current flow direction when a switch Q2, a switch Q4, a switch Q5, a switch Q7 and a first rectifier 21 are turned on.

When the switch Q1, the switch Q3, the switch Q6, the switch Q8 and the second rectifier Z2 are turned on, as shown in FIG. 10, in the power converter 400, current flows to the load through the switch Q1, a first LC resonant cavity defined by a resonant capacitor C1 and a resonant inductor L1, the switch Q3, the coil P1 included in coupling inductance 410, and returns to ground. Moreover, the current flows to the load through switch Q6, the second LC resonant cavity defined by resonant capacitor C2 and resonant inductor L2, the switch Q8, and the coil P1 included in coupling inductance 410, and returns to ground. In addition, through the magnetic coupling between the coil P1 and the coil S2, the current flows to the load through the second rectifier 22 and the coil S2 included in the coupling inductance 410, and returns to ground. Since the coil P1 is magnetically coupled with the coil S2, the current flowing through the coil P1 is equal to the current flowing through the coil P2 in magnitude in a case that a number of turns of the coil P1 is equal to a number of turns of the coil S2 and the parasitic is ignored. It should be noted that in the process of operating in this half cycle, the resonant capacitor C1 is charged and the resonant capacitor C2 is discharged.

When operating in the other half cycle, that is, when the switch Q2, the switch Q4, the switch Q5, the switch Q7 and the first rectifier 21 are turned on, as shown in FIG. 11, in the power converter 400, a current flows to the load through the switch Q7, the second LC resonant cavity defined by the resonant capacitor C2 and the resonant inductor L2, the switch Q5, and the coil P2 included in the coupling inductance 410, and returns to ground. Moreover, the current flows to the load through the switch Q4, the first LC resonant cavity defined by the resonant capacitor C1 and the resonant inductor L1, the switch Q2, and the coil P2 included in coupling inductance 410, and returns to ground. In addition, through magnetic coupling between the coil P2 and the coil S1, the current flows to the load through the first rectifier Z1 and the coil S1 included in the coupling inductance 410, and returns to ground. Similarly, since the coil P2 is magnetically coupled with the coil S1, the current flowing through the coil S1 is equal to the current flowing through the coil S2 in magnitude in a case that a number of turns of the coil P2 is equal to a number of turns of the coil S1 and the parasitic is ignored. It should be noted that in the process of operating in this half cycle, the resonant capacitor C2 is charged and the resonant capacitor C1 is discharged.

Regarding a relationship between an output voltage Vo and an input voltage Vin, the number of turns of the coil P1 is equal to the number of turns of the coil P2, the number of turns of the coil S1 is equal to the number of turns of the coil S2, and Vo=Vin*n2/[2*(n1+n2)], where n1 represents the number of turns of each of the coil P1 and the coil P2, and n2 represents the number of turns of each of the coil S1 and the coil S2. When the coil P1, the coil P2, the coil S1 and the coil S2 have a same number of turns, a gain ratio of the output voltage to the input voltage is 1:4.

In the power converter 400 of this example embodiment, the resonant inductor L1 and the resonant inductor L2 are independent of the coil S1, the coil S2, the coil P1 and the coil P2, and there is no coupling between the resonant inductors L1 and L2 and the coils S1, S2, P1, and P2.

According to this example embodiment, the power converter 400 may achieve the same effect as the power converter 300 of the third example embodiment, which will not be repeated here.

It should be noted that a topological structure of the power converter 200 in the second example embodiment of the present disclosure may be regarded as an evolution of a topological structure of the power converter 100 in the first example embodiment. The topological structure of the power converter 400 in the example embodiment 4 of the present disclosure may be regarded as a structure obtained by coupling the transformers in two-phase structure of the power converter 100 of the first example embodiment when the timing of the power converter 100 is staggered by 180 degrees and merging the primary windings. The topological structure of the power converter 300 of the third example embodiment of the present disclosure may be regarded as a structure obtained by merging the coil P1 and the coil S1 and merging the coil P2 and the coil S2 in the power converter 400 of the fourth example embodiment.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A power converter, comprising:
a first bridge arm including a first switch and a second switch connected in series to define a first connection point;
a second bridge arm including a third switch and a fourth switch connected in series to define a second connection point;
a first LC resonant cavity connected between the first connection point and the second connection point;
a first rectifier and a second rectifier including switches; and
a coupling inductance connected to the second switch, the third switch, the first rectifier and the second rectifier respectively; wherein
a center tap of the coupling inductance is connected to a load.

2. The power converter of claim 1, wherein
the coupling inductance includes a first coil, a second coil, a third coil and a fourth coil configured such that the first coil is magnetically coupled with the second coil, the third coil is magnetically coupled with the fourth coil, a center tap of a combination of the first coil and the second coil is connected to a center tap of a combination of the third coil and the fourth coil and the center taps are connected to the load; and
the first coil is connected to the second switch, the second coil is connected to the first rectifier, the third coil is connected to the third switch, and the fourth coil is connected to the second rectifier.

3. The power converter of claim 1, wherein
the coupling inductance includes a first coupling inductor and a second coupling inductor magnetically coupled with the first coupling inductor;
an end of the first coupling inductor is connected to the second switch and the third switch and is connected to the load, and another end of the first coupling inductor is connected to the first rectifier and the second rectifier, respectively; and
the second coupling inductor is connected in series with the first LC resonant cavity between the first connection point and the second connection point.

4. The power converter of claim 3, wherein
the first coupling inductor includes a first coil and a second coil connected in series;
an end of the first coil is connected to an end of the second coil to define the end of the first coupling inductor, another end of the first coil and another end of the second coil define the another end of the first coupling inductor, the another end of the first coil is connected to the first rectifier, and the another end of the second coil is connected to the second rectifier.

5. The power converter of claim 1, wherein
the first bridge arm includes a fifth switch and a sixth switch configured such that the fifth switch and a sixth switch are connected in series with the first switch and the second switch, and the fifth switch is connected to the sixth switch to define a third connection point;
the second bridge arm includes a seventh switch and an eighth switch configured such that the seventh switch and the eighth switch are connected in series with the third switch and the fourth switch, and the seventh switch is connected to the eighth switch to define a fourth connection point;
the power converter further comprises a second LC resonant cavity connected between the third connection point and the fourth connection point; and
the fifth switch is connected to the second switch to define a fifth connection point, the eighth switch is connected to the third switch to define a sixth connection point, and the coupling inductance is connected between the fifth connection point and the sixth connection point.

6. The power converter of claim 5, wherein
the coupling inductance includes a first coil and a second coil connected in series, and a center tap of a combination of the first coil and the second coil is connected to the load;
the first coil is connected to the sixth connection point, and is connected to the first rectifier; and
the second coil is connected to the fifth connection point, and is connected to the second rectifier.

7. The power converter of claim 5, wherein
the coupling inductance includes a first coil, a second coil, a third coil and a fourth coil configured such that the first coil is connected in series with the second coil, the third coil is connected in series with the fourth coil, a center tap of a combination of the first coil and the second coil is connected to a center tap of a combination of the third coil and the fourth coil and the center taps are connected to the load;
the first coil is connected to the sixth connection point, the second coil is connected to the fifth connection point, the third coil is connected to the first rectifier, and the fourth coil is connected to the second rectifier; and
the first coil is magnetically coupled with the fourth coil, and the second coil is magnetically coupled with the third coil.

8. The power converter of claim 1, wherein
a first group of switches includes the first switch, the third switch and the second rectifier;
a second group of switches includes the second switch, the fourth switch and the first rectifier;
the first group of switches are controlled to be turned on or off synchronously;
the second group of switches are controlled to be turned on or off synchronously; and
the first group of switches and the second group of switches are controlled to have an identical turn-on duty cycle.

9. The power converter of claim 8, wherein
each of the first group of switches and the second group of switches are controlled to have a turn-on duty cycle of 50% without considering dead zone; and
a phase difference between a control signal of the first group of switches and a control signal of the second group of switches is 180 degrees.

10. The power converter of claim 5, wherein
a first group of switches includes the first switch, the third switch, the sixth switch, the eighth switch and the second rectifier;
a second group of switches includes the second switch, the fourth switch, the fifth switch, the seventh switch and the first rectifier;
the first group of switches are controlled to be turned on or off synchronously;
the second group of switches are controlled to be turned on or off synchronously; and
the first group of switches and the second group of switches are controlled to have an identical turn-on duty cycle.

11. The power converter of claim 10, wherein
each of the first group of switches and the second group of switches are controlled to have a turn-on duty cycle of 50% without considering dead zone; and
a phase difference between a control signal of the first group of switches and a control signal of the second group of switches is 180 degrees.

12. The power converter of claim 5, wherein
the first LC resonant cavity includes a first resonant inductor and a first resonant capacitor connected in series;
wherein the second LC resonant cavity includes a second resonant inductor and a second resonant capacitor connected in series; and
a capacitance of the first resonant capacitor is equal to a capacitance of the second resonant capacitor.

13. The power converter of claim 12, wherein at least one of the first resonant inductor and the second resonant inductor is includes a circuit parasitic inductance.

14. The power converter of claim 5, wherein each of a resonant frequency of the first LC resonant cavity and a resonant frequency of the second LC resonant cavity is equal to an operation frequency of the power converter.

15. The power converter of claim 6, wherein a number of turns of the first coil is equal to a number of turns of the second coil.

16. The power converter of claim 2, wherein the first coil, the second coil, the third coil and the fourth coil have a same number of turns.
